(19) United States
(12) Patent Application Publication
(10) Pub. No.: US 2026/0214051 A1
(43) Pub. Date: Jul. 23, 2026

(54) NETWORK ADDRESSING FOR IMPROVED NETWORK ROUTING

(71) Applicant: Morgan Stanley Services Group Inc., New York, NY (US)

(72) Inventors: Vitaliy SHATS, New York, NY (US); David S. FISHER, Alpharetta, GA (US); Vishal VYAS, New York, NY (US); Rajeshwari RAGHUNATHAN, New York, NY (US); Raja Sekhar Reddy GOLAMARU, Alpharetta, GA (US)

(73) Assignee: Morgan Stanley Services Group Inc., New York, NY (US)

(21) Appl. No.: 19/035,321

(22) Filed: Jan. 23, 2025

(51) Int. Cl. H04L 45/745

(52) U.S. Cl. CPC H04L 45/745

(57) ABSTRACT

A device, system and method is provided for receiving a packet that can not be routed in a network because it does not contain a recognizable network address. The packet may be parsed to identify a marker indicating a potential network address. One or more recognizable addresses in a set of network-recognizable addresses may be identified that contain the marker. For each of the identified recognizable addresses, multiple sequential searches may be iteratively executed for a non-exact match of the recognizable address in the packet. In each sequential search, a proximity of a matching criteria for the non-exact match may be incrementally decreased until a non-exact match is detected or a termination criterion is reached. The packet may be addressed to the recognizable address if the non-exact match is detected. The packet may thus be routed in the network to a device uniquely identified by the recognizable address.

### FIELD OF THE INVENTION

The present invention relates generally to network addressing for improved network routing, and more specifically, to identification, alteration, repair or completion of partial, broken, unstructured or otherwise unrecognizable network addresses or accounts to complete or verify network routing and execute a variable gating process.

### BACKGROUND OF THE INVENTION

When a network routing system does not provide a structured format or protocol for network addresses, humans interfacing with that network often enter addresses to deliver network packets that are unrecognizable or inaccurate as defined in the system. For example, senders often provide a partial address, an address with syntax errors, or can insert, omit or permute numbers, words or characters in the address. Without accurate network addresses, the system cannot route those network packets that are returned undelivered.

Accordingly, there is a longstanding need in the art for an intelligent network router that can correct errors in human-entered addresses and identify intended, but not exactly matching, addresses to route these undeliverable network packets.

### SUMMARY OF THE INVENTION

To solve this longstanding need inherent in the art, a device, system and method is provided to accurately and efficiently automate system routing of otherwise undeliverable network packets by replacing their unrecognizable recipient addresses with intended, but not exactly matching, recognizable addresses.

Embodiments of the invention start this address matching process by scanning each incoming network packet (e.g., the entire header or an address field therein, and/or a part or whole of the payload) for a marker having a format or syntax associated in the system with network addresses. A marker format could include a contiguous sequence of symbols following a predefined syntax. In one example, the system may scan a packet header reciting “WOEF 101234876 JOHN DOE FEDDK” for a recognizable unique marker “101234876” while “101234876 JOHN DOE” is a complete address. Once a marker is identified in the packet, the system searches for addresses in an address repository containing the marker and retrieves and verifies if those addresses from the repository (fully or partially) match the packet address. In some cases, a packet scan may find a string that follows a marker format but, in fact, is not a marker. Such string will not be part of any address in the repository. In such case, the repository search will not find any address or may find a false positive address that will not be successfully verified. The system will continue searching the remainder of the packet for other markers until no more can be found. In other cases, the repository search may identify multiple markers in the packet which correspond to different addresses in the repository. In such case the system may verify if any of those addresses are present in the packet (fully or partially). If multiple addresses are found in the packet, the system may execute a conflict resolution processes to determine which is the most accurate match, or if there are multiple valid addresses in the same packet.

Once a repository address containing the packet marker is identified, the system may determine if the repository address matches a packet address. The system may initially search for an exact match of the network address between a data packet and system records, and then sequentially searching for non-exact matches with iteratively and gradually relaxed matching criteria (e.g., considering possible common mistakes senders are known to make). Matching criteria may be relaxed by decreasing a minimum proximity threshold of a matching criteria therebetween or decreasing the number or severity of matching rules. Embodiments of the invention balance opposing goals of increasing the probability of address matching (e.g., relaxing or lowering non-exact matching criteria) while decreasing the risk of misidentifying the address to reduce match false positives (e.g., maintaining minimal threshold matching criteria). In practice, embodiments of the invention were experimentally shown to automate network address matching, eliminating manual intervention, on 80% of incoming messages while maintaining a rate of misidentification as low as 1%. Network address matching rules may be tuned to further reduce false positives (e.g., preferred in high security applications with more severe consequences for erroneous routing) or further increase matching (e.g., preferred in applications that favor deliverability with more resilience to misrouted messages).

In accordance with an embodiment of the invention, a device, system and method is provided to route a packet with an unrecognizable network address that does not exactly match a set of addresses recognizable in a network (e.g., not listed in a network address repository or violating the network's address format rules). The packet may be scanned for a marker. An address repository may be searched for one or more addresses that match the marker. Each of those one or more repository addresses may be compared to the packet data to detect an exact or non-exact match between the packet data and the repository address. If no exact match is found, multiple sequential searches may be iteratively executed to detect a non-exact match between the packet data (unrecognizable as a network address) and the repository address (recognizable as a network address). In each sequential search, a proximity of a matching criteria for the non-exact match is incrementally decreased (e.g., decreasing a minimum match distance therebetween, decreasing the number of match criteria, using less rigorous criteria, etc.) until a non-exact match iteration detects a non-exact match between the packet data and the repository address or a minimum proximity threshold or other termination criterion is reached. The matching packet data (unrecognizable as a network address) may be replaced with the repository address (recognizable as a network address) (e.g., in the packet itself or in a linked memory field). The packet may then be routed in the network to a device uniquely identified by the replaced recognizable address. Accordingly, the initially undeliverable packet having no recognizable network address may be delivered to the intended recipient in the network.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates a system for network addressing for improved network routing, in accordance with an embodiment of the invention; and

FIG. 2 is a flowchart of a method for network addressing for improved network routing, in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

Embodiments of the invention may detect undeliverable network messages with recipient addresses that do not exactly match any of a set of addresses recognizable in a system and so, the messages cannot be routed in, or its instruction(s) executed by, the system (e.g., the recipient network address does not match any known network address or do not comply with network address format rules or protocols so no match is possible). Embodiments of the invention may correct, repair or otherwise alter those unrecognizable network addresses to identify a closest non-exact matching recognizable address of an intended network recipient.

The network address matching process may be an iterative multi-pass process initiated by scanning a packet for marker(s), searching for those marker(s) in an address repository, and determining if repository addresses, that include those marker(s), exactly or non-exactly match the packet data. Non-exact matching may be determined initially with a relatively high proximity match criteria that, in each sequential iteration, may be incrementally relaxed and decreased until a match is found or a termination criterion is reached, such as, a minimum proximity threshold, a timeout or a maximum iteration number is reached. Iteratively relaxing the matching criteria in multiple iterations from relatively high to low proximities may improve the accuracy of network addressing by detecting closer matches in earlier iterations, and only relaxing matching criteria when a higher proximity match is not possible, thereby reducing false positives compared to a single iteration using a relatively moderate or lower level matching criteria. The multi-pass network address matching may also improve network routing efficiency increasing the speed of network matching by matching based on a criteria subset for only the current matching level, terminating the iterative process when a match is found, thereby eliminating later iterations and comparisons based on their lower proximity match criteria, resulting in an analysis of fewer total criteria compared to a single iteration analyzing all match criteria. Matching using fewer proximity match criteria also reduces the chance of multiple matches and thus reduces conflict resolution processes to determine which is the accurate match and which is/are the false positive match(es), further reducing computational requirements and increasing network routing speed and efficiency. Multi-pass network address matching may also increase efficiency by allowing parallelization or batching of computations, for example, executing each of the iterations in parallel on a batch of multiple network addresses. In some embodiments, an intelligent processor may distribute parallelized computational tasks among multiple processors or devices in a non-deterministic and/or non-repeatable distribution to optimize efficiency based on available computational resources, capacities or times of the multiple processors or devices to increase the speed of address matching.

In some embodiments, the multi-pass match analysis may potentially detect multiple repository matches in the packet. In some embodiments, each match may have a likelihood of accuracy or error computed therefore (e.g., the match proximity criterion level or number of pass iterations for which the match was detected). When the likelihood of accuracy is low or error is high (e.g., relative to a tunable threshold), the match may require verification (e.g., confirmation from the sender or receiver or to satisfy additional alternative matching criteria). In some embodiments, the later the iteration in which the match was detected or lower the accuracy or proximity of the matching criteria, the more rigorous its verification process. For example, addresses matched at a highest accuracy/proximity or earlier iteration may undergo none or less rigorous verification compared to addresses matched at a lower accuracy/proximity or later iteration relative thereto. Additionally or alternatively, addresses matched with a below threshold proximity criteria or above threshold iteration number may undergo an additional verification test.

In some embodiments, accuracy statistics for network routing (e.g., accurate network address matching and/or misidentification rate) may be aggregated in real-time e.g., across the entire network, one or more devices, over a period of time, etc. Those real-time accuracy statistics may be fed back into the match analysis to adjust or tune its criteria minimum threshold(s), number of multi-pass iterations, allowable rate of false positives, etc., for example, to meet predetermined or desired configurable accuracy standards while optimizing routing speeds.

In some embodiments, a matching criterion may be fuzzy or soft (e.g., matching with an above threshold probability) to identify close or approximate matches (e.g., recipient name that almost matches, allowing misspelling of up to one letter), while other matching criteria may be hard (e.g., only allowing exact, but not approximate, matches) that precludes close matching (e.g., numerical account numbers, IP or port address numbers, etc.). In some embodiments, multiple matching criteria may be scored as a weighted multi-variable sum. Matching may be weighted differently, for example, based on the data type, location of matching data in the address sequence (e.g., prefix and/or suffix weighed less than middle location segment data), matching data size (e.g., longer consecutive sequence matches weighed more than shorter, broken or out-of-order sequence matches), etc.

In some embodiments, instead of starting address matching at the same criteria level for all addresses, each packet may be analyzed for repository addresses and initiated at a first iteration with a criteria level commensurate with the packet's quality (e.g., its marker(s) compliance with network formatting rules). For example, a packet with markers with relatively higher compliance to format rules (e.g., the exact length of a continuous sequence of symbols associated with network addresses) may initiate the multi-pass address search at a more rigorous or higher criteria level than one with markers with relatively lower compliance to format rules (e.g., having partial length, non-contiguous, and/or different symbol type as associated with network addresses).

In some embodiments, once a non-exact matching repository address is found to match packet data, the packet's unrecognizable network address may be replaced with that recognizable address (e.g., in the packet's message header or an address-linked memory structure). The network router may then route and deliver the previously undeliverable message in the network to a recipient device with the recognizable address (e.g., updating the address-linked memory structure). Altering or replacing the recipient address in the message may physically control and alter the operation of network devices by stopping, canceling and/or rerouting network message traffic transmitted and received between the network devices, controlling memory structures to update their address-linked data, and/or intelligently redistributing parallelized computational readdressing tasks among multiple network devices (e.g., in a non-deterministic and/or non-repeatable distribution to optimize system efficiency).

In some embodiments, once the message is delivered, the recipient device may process and execute its message content comprising one or more variable gating instruction(s). The variable gating instruction(s) may, for example, trigger a gate to cause an action, such as, transmit an alarm, execute a security task (e.g., locking or unlocking a door or gate, rotate a security camera, etc.), turn on/off or alter the operation of devices, issue a token or key to a device or account, etc.

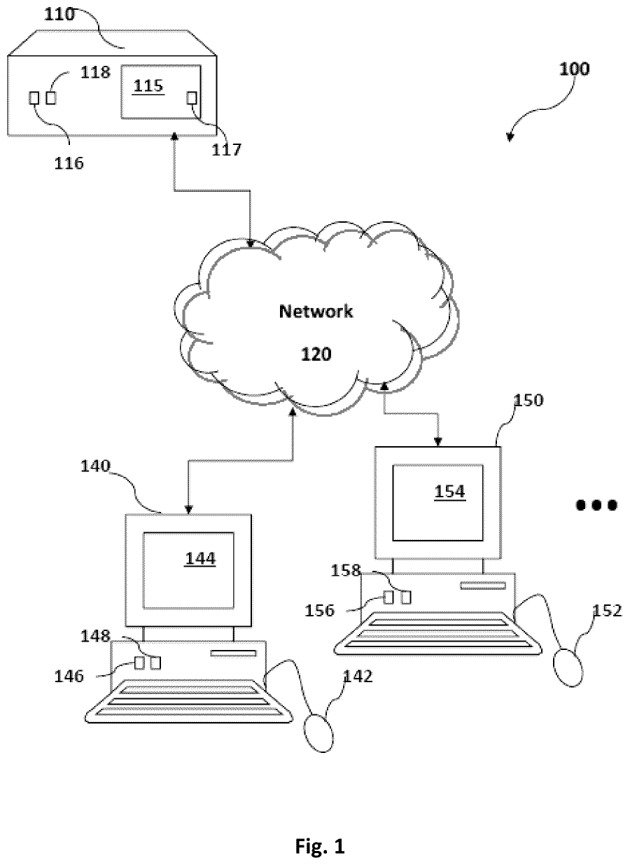

Reference is made to FIG. 1, which schematically illustrates a system 100 for network addressing for improved network routing, in accordance with an embodiment of the invention. Embodiments described herein may be executed using any single or combination of devices and/or components of system 100 of FIG. 1 (or other devices may be used).

System 100 may include a network-connected device 140 sending a packet comprising a recipient address intended for, but different than the address of, recipient device 150. One or more network server(s) 110 (e.g., a router with a repository of network addresses in one or more database(s) 115) may receive the packet. Network-connected device 140 may be operated by a user (e.g., that entered the recipient address with errors) or operated in a different network or using a different protocol (e.g., using address formats different from those in this network) and so, may generate the recipient address that is unrecognizable to network server(s) 110 (e.g., not found in the network address repository or that violates the network's format or protocol rules), rendering the packet undeliverable or unexecutable by network server(s) 110. Network server(s) 110 may scan the packet for marker(s), search a network address repository for address(es) that partially or fully contain the marker(s), and execute a multi-pass address matching process to detect the network-recognizable repository address(s) of recipient device 150 that most closely matches the packet's unrecognizable address. Network server(s) 110 may replace the unrecognizable network address in the packet (e.g., directly or a linked memory structure) with the matched recognizable address. The packet may be routed to the recipient device 150 (e.g., directly sending recipient device 150 the packet, updating a memory field associated with recipient device 150, or triggering an action or instruction in the packet associated with recipient device 150). In one embodiment, the delivered packet's instruction may be executed to activate a variable gate for recipient device 150, such as, transmit an alarm thereto, execute a security task thereat (e.g., locking or unlocking a door or gate, rotate a security camera, etc.), turn on/off or alter the operation of the recipient device, issue a token or key to the recipient device or its associated user or account such as a monetary transaction or market trade for the recipient device's account, etc.

Each device(s) 110, 115, 140, and 150, may include one or more server(s), storage device(s), computer(s) such as, personal computers, desktop computers, mobile computers or devices, laptop computers, and notebook computers or any other suitable device such as a cellular telephone, personal digital assistant (PDA), video game console, etc., and may include wired or wireless connections or modems. Device(s) 140 and 150 may include respective memories 148 and 158 for storing client information. Device(s) 140 and 150 may include one or more input devices 142 and 152, respectively, for receiving input from a user. Device(s) 140 and 150 may include one or more output devices 144 and 154 (e.g., a monitor or screen) for displaying data to the data owner provided by or for network server(s) 110.

Database(s) 115 may be a storage device comprising one or more memor(ies) to store data 117 (e.g., a repository of network addresses recognized or known to be associated with one or more recipient device(s), user(s) or account(s) 150). In alternate embodiments, database(s) 115 may be omitted and network address repository 117 may be stored in an alternate location, e.g., exclusively or additionally locally in memory unit(s) 148 and 158 of the respective entity devices, or in device memory 118.

Any or all of system 100 devices may be connected via one or more network(s) 120. Network 120 may be any public or private network such as the Internet. Access to network 120 may be through wire line, terrestrial wireless, satellite or other systems well known in the art.

Each system device 110, 115, 140, and 150 may include one or more controller(s) or processor(s) 116, 111, 146, and 156, respectively, for executing operations according to embodiments of the invention and one or more memory unit(s) 118, 113, 148, and 158, respectively, for storing data (e.g., address, device, user, account information and variable gate information associated therewith) and/or instructions (e.g., software for executing operations, such as activating a variable gate, according to embodiments of the invention) executable by the processor(s). Memory unit(s) 118, 113, 148, and 158 may include a computer or processor non-transitory readable medium, or a computer or processor non-transitory storage medium, such as for example a memory, a disk drive, or a USB flash memory encoding, including, or storing instructions, e.g., computer-executable instructions, which, when executed by a processor or controller (e.g., one or more of processor(s) 116, 111, 146, and/or 156), carry out methods disclosed herein. Processor(s) 116, 111, 146, and/or 156 may include, for example, a central processing unit (CPU), a digital signal processor (DSP), a microprocessor, a controller, a chip, a microchip, an integrated circuit (IC), or any other suitable multi-purpose or specific processor or controller. Memory unit(s) 118, 113, 148, and/or 158 may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units.

Network server(s) 110 may repeat the address matching process for each of multiple network addresses in a single packet. The repetition may be executed in sequence or in parallel.

When an incoming message or data packet arrives at the boundary of a transfer system, the system determines a recipient to which the message is directed. The incoming message typically contain a network address (e.g., alphanumeric sequence such as a name and/or number). Embodiments of the invention may determine the message's intended recipient by performing the following example steps:
1. Parse the network address in the message (e.g., in a recipient field in the message header). In an embodiment, an address parser may search the message for a marker that is a contiguous sequence of alphanumeric characters or numbers indicating a potential candidate network address that conforms to the network's address format rules (e.g., length, syntax, prefix, etc.).
2. Search the network repository for one or more network addresses that partially fully, exactly or non-exactly matches or contains the marker.
3. Verify if each of one or more repository addresses sufficiently matches the packet's data (e.g., an unrecognizable address in the message) so the packet can be automatically routed to that address or its data can be linked to that address.

3. When the message's address and/or name is unknown or unrecognizable in the network repository or improperly formatted, embodiments of the invention execute an address matching or readdressing process to correct address errors (e.g., due to human entry error, inter-system syntax differences, etc.). The readdressing process may include multiple passes to detect non-exact address matches between the repository addresses and the packet's unrecognizable address by iteratively and gradually relaxed matching criteria (e.g., incrementally increasing the allowed distance for matching criteria, incrementally decreasing the number or rigor of matching criteria, etc.).

Note, the below logic includes alphanumeric sequences referred to as “drop” keywords. Drop keywords may be ignored or weighed less than other alphanumeric sequences in the address matching logic. Drop keywords may include common, placeholder, dummy or optional alphanumeric sequences considered nonessential to identifying addresses (e.g., an IP address prefix “0000,” a web address prefix “HTTPS” or “www,” an account suffix “TRUST” or “HOLDING,” etc.). Including drop keywords in the address matching logic may increase the probability of incorrect address matching. Drop keywords may be configurable and may be added, deleted or weighed differently, over time in the address matching logic.

Note, during address matching, an address from the network address repository can be found as part of a larger or smaller alphanumeric sequence in the message. In some embodiments, such partial matches of overlapping sequences may be considered a true match. For example, a message recipient address “alpha.com” may match a repository address “alpha.com/payment,” or vice versa.

As a non-limiting example for demonstrative purposes, network addressing may proceed, for example, as follows:
1. Convert markers in the packet and/or known addresses in the network address repository to a standardized format. For example, convert all characters to upper case. Drop ‘/’ or other symbols. Replace all characters other than A-Z with spaces. Then eliminate duplicate spaces and leave single space as a separator between words. The resulting address may be a string of alphanumeric characters referred to as a “repository name”. E.g. given the following repository name: “-BNK-FBO NATHAN FAMILY @123 TR//UST”, the resulting repository name will be “BNK FBO NATHAN FAMILY TRUST”-note a leading space. Note, the ‘/’ is not replaced with a space but is dropped-TRUST becomes a whole word.
2. Extract and parse a field from the message that is a candidate to contain a network address (e.g., based on syntax, filed position, labeled or including “Recipient:” or “To:”, etc.). Convert all characters to upper case. Drop all characters other than A-Z (that includes spaces and ‘/’). E.g. if the field had the following value: “BNK-FBO NATHAN///FAMILY @123 TRUST” then after this step it will become: “BNKFBONATHANFAMILYTRUST”.
3. Using two (or more) words at a time from the repository name, search for each combination of words in the parsed message field until all combinations are exhausted. For the address match to succeed, the two words from the repository name should be in the same order in the message field. For example, the two words from the repository name can be used only if:
   a. Both words are at least two characters long.
   b. Combined length of both words is more than 5 characters (e.g. BB BBBBB is allowed, while BB BBB is not).
   c. Both words are not drop keywords. See Appendix B for example logic to identify drop keywords.
   Note that some keywords on the drop keyword list comprise multiple words (e.g. “LIMITED LIABILITY COMPANY”). When picking single words from the repository name, such multi-word drop keywords will not be found in this step.
   d. One of the two words is allowed to be a drop keyword but only if it is more than 4 characters long (e.g. HTTPS is allowed but WWW is not). Note that only alphanumeric characters are considered in the 4 character limit, the leading and trailing spaces are not. E.g. “FUND 6”, “MISS 5” should not be used in this step since their length without the spaces is 4 (e.g. the number refers to the length of the keyword).

All length limits e.g., on keywords may be configurable/adjustable.

In the previous example from step 1 where the repository name string is “BNK FBO NATHAN FAMILY TRUST”, the network addresser may consider the following example two word combinations (note, the percentage sign is used as a word separator here):

| | COMBINATIONS | DESCRIPTION |
|---|---|---|
| 1 | BNK%FBO | Not searched because both words are drop keywords |
| 2 | BNK%NATHAN | Not searched because BNK is a drop keyword which too short |
| 3 | BNK%FAMILY | Not searched because both words are drop keywords |
| 4 | BNK%TRUST | Not searched because both words are drop keywords |
| 5 | FBO%NATHAN | Not searched because FBO is drop keyword which is too short |
| 6 | FBO%FAMILY | Not searched because both words are drop keywords |
| 7 | FBO%TRUST | Not searched because both words are drop keywords |
| 8 | NATHAN%FAMILY | Searched for matching as it satisfies both conditions. Although |
| | | FAMILY is a drop keyword, it is more than 4 chars long |
| 9 | NATHAN%TRUST | Searched for matching as it satisfies both conditions. Although |
| | | TRUST is a drop keyword, it is more than 4 chars long |
| 10 | FAMILY%TRUST | Not searched because both words are drop keywords |

Assuming the message field has value “BNKFBONATHANFAMILYTRUST” from step 2, the name matching would succeed at the row #8 in the table above.

Note, the following steps 4-7 may be considered together, in which 4-6 are preparation steps and the name match comparison is executed in step 7.
4. Take the original repository name and the original message field value. Convert all characters to upper case. Replace all characters other than A-Z and ‘/’ with spaces. Then eliminate duplicate spaces and leave single space as a separator between words. E.g. given the repository name “BNK-FBO F. NATHAN FAMILY @123 U/A/D CARE-OF ACARE/OFA,” the repository name would become “BNK FBO F NATHAN FAMILY U/A/D CARE OF ACARE/OFA”; and given the repository name “BNK F. NATHAN AND JOHN ACARE/OFA JANE,” the repository name would become “BNK F NATHAN AND JOHN ACARE/OFA JANE”.
Note, step 4 eliminates duplicate spaces and keeps ‘/’ in order to detect drop keywords in step 5.
5. Scan the drop keyword list to identify if any of the drop keywords are present in the repository name and the message field. See Appendix C for example logic to identify drop keywords. If any drop keyword exists in the repository name, replace them with spaces. Then eliminate duplicate spaces and leave single space as a separator between words.
E.g. In the previous example from step 4 the repository name would become “F NATHAN ACARE OFA”. Note, that BNK, FBO, FAMILY, U/A/D, “CARE OF”, and ‘/’ were recognized as drop keywords. CARE/OF was not recognized as a drop keyword as it has a ‘/’ in it. Note that on the list of drop keywords, ‘/’ comes after “CARE OF”-after the ‘/’ is recognized and replaced with a space, the “CARE OF” is no longer evaluated. If any drop keyword exist in the parsed message field, drop them. Then drop all the spaces as well.
E.g. the instruction value “BNK F NATHAN AND JOHN ACARE/OFA JANE” would become “FNATHANJOHNACAREOFAJANE” as BNK and AND are drop keywords.
6. Identify individual words (separated by spaces) in the repository name and note their lengths. Note, only these words will be used by the remaining rules.
E.g. continuing with the example from step 5, repository name “F NATHAN ACARE OFA” contains four words with lengths:

| | |
|---|---|
| F | 1 |
| NATHAN | 6 |
| ACARE | 5 |
| OFA | 3 |

7. If the combined length of all the words identified in step 6 is less than six then skip step 7 and proceed to step 8.
Search for all repository words within the message field value. For a match to succeed, all of them have to be found in the same order.
E.g. continuing with the previous examples, the words F, NATHAN, ACARE, OFA will be found in this order in the instruction “FNATHANJOHNACAREOFAJANE”.
8. If not found, proceed, for example, as follows:
   a. Search for every two word combination identified in step 6 in the message field in the same order. Search for only those word combinations whose combined length is more than 5 characters.
   E.g. assuming repository name “J ANDREWS F MADISON” consider the following combinations:

| | COMBINATIONS | DESCRIPTION |
|---|---|---|
| 1 | J%ANDREWS | Searched because total length is more than 5 |
| 2 | J%F | Not searched because total length is not more than 5 |
| 3 | J%MADISON | Searched because total length is more than 5 |
| 4 | ANDREWS%F | Searched because total length is more than 5 |
| 5 | ANDREWS%MADISON | Searched because total length is more than 5 |
| 6 | F%MADISON | Searched because total length is more than 5 |

Note, step 8a differs from step 3 in which the ‘/’ are dropped while in step 4 they are replaced with spaces, so “JOHN/SMITH” would be searched as a single word JOHNSMITH in 3 while in step 8 JOHN and SMITH would be searched separately. Also, there is no limit on the length of a word in step 8a-even single-letter words are considered.
E.g. End to end example: assuming the repository name is “JOHN-MARRY/SMITH” and the message field value is “JOHN SMITH” then the name matching would succeed only in step 8a. A match will be identified for JOHN % SMITH.
   b. For every two word combination identified in step 6, select the first letter of the first word and the complete second word and search for them in the message field in the same order. Search only for those combinations whose combined length is more than 5 characters.
   E.g. assuming the repository name “J ANDREWS F MADISON” consider the following combinations:

| | COMBINATIONS | DESCRIPTION |
|---|---|---|
| 1 | J%ANDREWS | Searched because total length is more than 5 |
| 2 | J%F | Not searched because total length is not more than 5 |
| 3 | J%MADISON | Searched because total length is more than 5 |
| 4 | A%F | Not searched because total length is not more than 5 |
| 5 | A%MADISON | Searched because total length is more than 5 |
| 6 | F%MADISON | Searched because total length is more than 5 |

Assuming the instruction had value “XANDREY FMADISON”, the name matching would succeed in row 5 in the table above. Note, the sender has misspelled ANDREWS.
   c. For every two word combination identified in step 7, select the complete first word and the first letter of the second word and search for them in the message field in the same order. Search only for those combinations whose combined length is at least 6 characters.
   E.g. assuming the repository name “J ANDREWS F MADISON” consider the following combinations:

| | COMBINATIONS | DESCRIPTION |
|---|---|---|
| 1 | J%A | Not searched because total length is not more than 5 |
| 2 | J%F | Not searched because total length is not more than 5 |
| 3 | J%M | Not searched because total length is not more than 5 |
| 4 | ANDREWS%F | Searched because total length is more than 5 |
| 5 | ANDREWS%M | Searched because total length is more than 5 |
| 6 | F%M | Not searched because total length is not more than 5 |

Assuming the instruction had value “XANDREWSY XMIDSON”, the name matching would succeed only in row 5 in the table above. Note, the sender has misspelled MADISON.
   d. Repeat step 8a but swap the word order. Search only for those combinations where each word is more than 2 characters long.
   E.g. assuming the repository name “J ANDREWS F MADISON” consider the following combinations:

| | COMBINATIONS | DESCRIPTION |
|---|---|---|
| 1 | ANDREWS%J | Not searched because both words are not more than 2 chars long |
| 2 | F%J | Not searched because both words are not more than 2 chars long |
| 3 | MADISON%J | Not searched because both words are not more than 2 chars long |
| 4 | F%ANDREWS | Not searched because both words are not more than 2 chars long |
| 5 | MADISON%ANDREWS | Searched because both words are more than 2 chars long |
| 6 | MADISON%F | Not searched because both words are not more than 2 chars long |

Assuming the instruction had value “XMADISON XANDREWSY”, the name matching would succeed in row 5 in the table above.
   9. If not found, pick one word at a time from the repository name and try to find it in the instruction. Try only those words that are more than 5 characters long. E.g. assuming the repository name “J ANDREWS F MADISON” consider the following combinations:

| | COMBI- | |
|---|---|---|
| | NATIONS | DESCRIPTION |
| 1 | J | Not searched because word is not more than 5 chars |
| | | long |
| 2 | ANDREWS | Searched because word is more than 5 chars long |
| 3 | F | Not searched because word is not more than 5 chars |
| | | long |
| 4 | MADISON | Searched because word is more than 5 chars long |

Assuming the instruction had value “XANDREWSY CORP”, the name matching would succeed only in row 2 in the table above.
   10. If not found, proceed to the next field from the message that is a candidate to contain a network address and repeat the process (e.g., steps 2-9).

### Appendix A. General Notes on Drop Keywords.

Note that there are three kinds of keywords defined in the example drop keywords list:
“SYSTEM 6”—not surrounded with spaces.
“TRUST 6”—has a trailing space.
“FUND 6”—has both a leading and trailing space.

If spaces are defined as part of a drop keyword, they may be considered as integral part of the keyword. Such keywords have to be found in the repository name and the message with those spaces in order to be treated as drop keywords.

E.g. “aSYSTEMa SYSTEM ABC”-SYSTEM and SYSTEM are drop keywords as SYSTEM is not surrounded with spaces on the drop list and the spaces do not matter.

“aTRUST TRUSTb”-TRUST will be identified as a drop keyword as it has a trailing space but TRUST will not be as it does not have a trailing space.

“aFUND FUNDb FUND ABC”-FUND will not be identified as a drop keyword as it is missing a leading space; FUND will not be identified as it is missing a trailing space; FUND will be identified as it has both leading and trailing spaces.

Note, if a word is defined with a trailing space, it may still be identified as a drop keyword even without a trailing space, e.g., only if it is encountered at the end of the string. In other words, if it is encountered at the end of the string, the trailing space may be assumed.

E.g. the word TRUST and FUND may be identified as drop keywords in the following strings: “ABC TRUST”, “ABC FUND”.

Appendix B. Checking if a Word from the Repository or Instruction is a Drop Keyword in Step 3.

Note that multi-word keywords like “CARE OF” may not be identified here as “CARE” and “OF” considered separately.

The following logic may be applied to identify if a given word from the repository or the message field is a drop keyword:
1. Regardless of whether there are surrounding spaces or not, the word may be searched in the drop keyword list without surrounding spaces.
2. If there is a trailing space, the word may be searched for with the trailing space.
3. If the word is the last in the string, then add a trailing space to it and search for it with a trailing space.
4. If there are both leading and trailing space, the word may be searched for with both leading and trailing space.
5. If the word is the last in the string and has a leading space, then add a trailing space to it and search for it with both leading and trailing space.

E.g. in case of a string “SYSTEM SYSTEM SYSTEM”, each of the three words will be found on the list in step #1.

E.g. in case of a string “TRUST TRUST TRUST”, the first two words will be found on the list in step #2, and the third word will be found in step #3.

E.g. in case of a string “FUND FUND FUND”, the first word will not be found on the list at all, the second will be found in #4, the last in #5.

E.g. in case of a string “ABC ASYSTEMA XYZ”, ASYSTEMA will be looked up and will not be found. SYSTEM will not be looked up.

Appendix C. Checking if a Drop Keyword from the Drop Keyword List is Present in the Repository Name or the Message Field in Step 5.

Note, multi-word keywords may be defined on the drop keyword list to be considered.

E.g. the keyword “CARE OF” may be identified in the string “IN CARE OF JOHN SMITH” but not in the string “IN CAREOF JOHN SMITH”.

As per Appendix A, if a drop keyword has leading/trailing spaces, they may be considered as integral part of the keyword.

E.g. “CARE OF” should be identified in the string “ACARE OFB” as “CARE OF” is defined without surrounding spaces;

“TRUST” should be identified in the string “ABC TRUST” as a trailing space is assumed at the end of the string;

“TRUST” should not be identified in the string “TRUSTABC” as the trailing space is missing;

“FUND” should be identified twice in the strings “ABC FUND FUND” as a trailing space is assumed at the end of the string; and “FUND” should not be identified in the string “AFUND FUNDB AFUNDB”.

Note the following special case. There could be two or more drop keywords in the repository name or the message field next to each other. Each may be defined with the surrounding spaces. Both should be identified and dropped. E.g. consider “JOHN X I JANE” value of the repository name. It contains two drop keywords “X” and “I”. The space between the keywords is shared and is applicable to both the X and the I. After “X” is dropped, the I may still be recognized as a drop keyword since it had a leading space before the “X” was dropped.

The aforementioned example steps, appendices, data types, alphanumeric types, strings, formats, rules, etc. are only shown as a non-limiting example for demonstrative purposes, and additional or alternative ones may also be used.

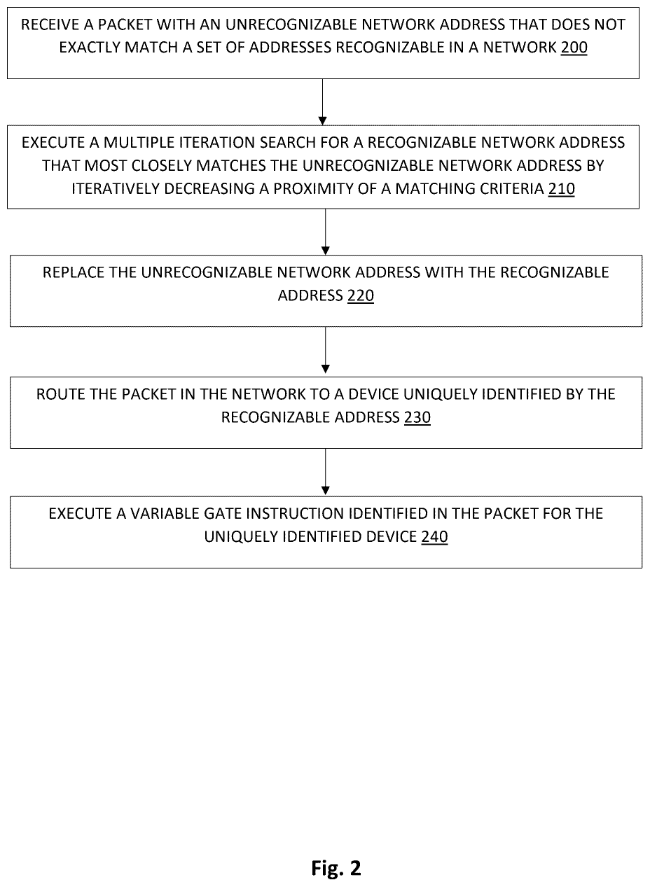

Reference is made to FIG. 2, which is a flowchart of a method for network addressing for improved network routing, in accordance with an embodiment of the invention. The steps described in reference to FIG. 2 and hereinabove may be executed using hardware devices described in reference to FIG. 1 (e.g. one or more network server(s) 110 using one or more processor(s) 116 of FIG. 1). Additionally or alternatively, other devices may be used.

In operation 200, one or more processor(s) (e.g., at network server(s) 110) may receive a packet (e.g., from network-connected device 140) with an unrecognizable recipient address that does not exactly match a set of addresses recognizable in a network and so is undeliverable and its content instructions are unexecutable. The packet's recipient address may be intended for, but different than the address of, a recipient (e.g., recipient device 150 or an associated user or account). The one or more processor(s) may parse the packet for one or more marker(s) and may detect one or more recognizable address(es) in a network address repository that partially or fully and exactly or non-exactly match or contain those marker(s).

In operation 210, one or more processor(s) may iteratively execute a multi-pass address matching process to determine if any of those detected recognizable address(es) (e.g., found in the network address repository) match the packet's data (e.g., currently unrecognizable recipient address). The one or more processor(s) may iteratively execute multiple sequential non-exact match comparisons between the recognizable repository address(es) containing packet marker(s) and the packet's data (e.g., currently unrecognizable network address). In each sequential iteration, the match criteria may be relaxed, such that, a proximity of a matching criteria for the non-exact match may be incrementally decreased until a match with a recognizable address is detected, a minimum proximity threshold is reached, or a timeout or maximum iteration number is reached. Decreasing the proximity of the matching criteria may include decreasing a continuous proximity of the matching criteria (e.g., a distance between alphanumeric addresses), decreasing the number of match criteria, decreasing the rigor of the matching criteria (e.g., requiring shorter character sequences to match, allowing out of order sequences to match, allowing overlapping without completely matching), etc. In some embodiments, the match proximity or level or rigor of matching may be clearly measurable by the criteria themselves (e.g., increasing proportionally to the number of consecutive matching alphanumeric numbers, the number of criteria, etc.). Additionally or alternatively, the match proximity may be measured based on the difficulty or ease of finding a match or the accuracy/error of the match results (e.g., increasing disproportionally to the number of matches or false positives on a sample or real address match). In some embodiments, the minimum proximity threshold may be tuned, for example, decreasing the minimum proximity threshold (making it harder to match) to increase a probability of detecting a recognizable address match or increasing the minimum proximity threshold (making it easier to match) to reduce a risk of error in detecting the recognizable address match. The minimum proximity threshold may be tuned responsive to a feedback signal indicating the accuracy or speed of the matching algorithm (e.g., to maintain a minimum threshold accuracy or speed).

The multi-pass address matching process may include the following example five match iterations, where the proximity of the matching criteria is incrementally decreased in the first to fifth iterations:
a first iteration that detects a non-exact match when the unrecognizable and recognizable network addresses contain the same multiple contiguous sequences of a plurality of characters that are in the same order and have a cumulative length of characters greater than a first value (e.g., Step 3 above);
a second iteration that detects a non-exact match when the unrecognizable and recognizable network addresses contain the same multiple contiguous sequences of one or more characters that are in the same order and have a cumulative length of characters greater than a second value (Step 7 above);
a third iteration that detects a non-exact match when the unrecognizable and recognizable network addresses contain the same multiple contiguous sequences of one or more characters that are in the same order or have a cumulative length of characters greater than a third value (Steps 8a and 8b above);
1 a fourth iteration that detects a non-exact match when the unrecognizable and recognizable network addresses contain the same first character of one of, and entirety of another one of, multiple contiguous sequences of one or more characters that are in the same order and have a cumulative length of characters greater than a fourth value (Step 8c above); and
a fifth iteration that detects a non-exact match when the unrecognizable and recognizable network addresses contain the same single contiguous sequence of a plurality of characters that have a cumulative length of characters greater than a fifth value (Step 9 above).

Any additional or different iterations or combinations of iterations and variables may be executed in between these five iterations. For example, incrementing a sequence of match iterations of incrementally fewer numbers of contiguous sequences of a plurality of matching or overlapping characters, until a minimum match length is reached.

It may be appreciated that the order of these match iterations (e.g., first, second, . . . ) are relative to each other (e.g., not absolute, as other match iterations may precede or separate them, and some iterations may be added or skipped), some iterations of one of these types may be repeated multiple times (e.g., the first iteration may be repeated by incrementally decreasing the first value to achieve multiple iterations of its type by matching word segments with iteratively decreasing character-length; the matching criteria proximity is thus incrementally decreased proportionally to the first value), and the order of these iterations may be changed (e.g., when similar criteria rigor is used, or that allows iteratively increasing matching criteria proximity for a subset of iterations, deviating from the otherwise iteratively decreasing matching criteria proximity; otherwise only exclusively iteratively (e.g., monotonically) decreasing matching criteria proximity is allowed).

In some embodiments, prior to one or more (all) of the match iterations, one or more processor(s) may drop predefined keywords from the unrecognizable network address that have a length of characters less than a sixth value. In some embodiments, the minimum proximity threshold weighs prefixes and suffixes less than middle segments of the unrecognizable network address.

In operation 220, one or more processor(s) may replace the unrecognizable network address with the detected recognizable address (e.g., directly in the packet, such as in the packet's header, or in a memory structure linked to the recognizable addresses, such as to update its information based on the packet's content instructions, such as, to execute a variable gate associated therewith).

In operation 230, one or more processor(s) may route the packet in the network to a device uniquely identified by the recognizable address. Routing may include directly transmitting the packet to the device, updating a memory field associated with the device, or triggering an action or instruction in the packet associated with or at the device.

In operation 240, one or more processor(s) may execute a variable gate instruction identified in the packet for the uniquely identified device, such as, to route the packet, execute the packet's instruction such as to trigger an action, execute or issue a token or key such as a transaction associated with an account linked to the recognizable address.

Other operations or orders of operations may be used.

In various embodiments, the network address may include an IP address, a web address, a device identifier, an account name, an account identifier, a user name, a user identifier, and/or other identifiers of users, devices and/or accounts, such as, a serial number or other unique alphanumeric sequence.

It may be appreciated that “real-time” may refer to instantly or, more often, at a small time delay of, for example, between 0.01 and 10 seconds, during, concurrently, or substantially at the same time as. Analyzing addresses, intercepting, rerouting or terminating packets, and/or executing the packet's variable gate instruction, may all be performed, for example, at the same time as, at a time delay from, or during the same network communication (e.g., web) session as the packet transmission.

One skilled in the art will realize the invention may be embodied in other specific forms without departing from the spirit or essential characteristics thereof. The embodiments described herein are therefore to be considered in all respects illustrative rather than limiting. In detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention.

Embodiments may include different combinations of features noted in the described embodiments, and features or elements described with respect to one embodiment or flowchart can be combined with or used with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

1. A method for network routing, the method comprising:
receiving a packet that can not be routed in a network because it does not contain a recognizable network address in a set of addresses recognizable in the network;
parsing the packet to identify a marker indicating a potential network address;
identifying one or more recognizable addresses that contain the marker in the set of addresses recognizable in the network;
for each of the identified recognizable addresses containing the marker, iteratively executing multiple sequential searches to detect a non-exact match between the recognizable address containing the marker and data in the packet, wherein in each sequential search a proximity of a matching criteria for the non-exact match is incrementally decreased until a non-exact match is detected or a termination criterion is reached;
addressing the packet to the recognizable address if a non-exact match thereof in the packet is detected; and
routing the packet in the network to a device uniquely identified by the recognizable address.

2. The method of claim 1 comprising executing a first sequential search detecting the non-exact match when the packet and the recognizable network address contain the same multiple contiguous sequences of a plurality of characters that are in the same order and have a cumulative length of characters greater than a first value.

3. The method of claim 1 comprising executing a second sequential search detecting the non-exact match when the packet and the recognizable network address contain the same multiple contiguous sequences of one or more characters that are in the same order and have a cumulative length of characters greater than a second value.

4. The method of claim 1 comprising executing a third sequential search detecting the non-exact match when the packet and the recognizable network address contain the same multiple contiguous sequences of one or more characters that are in the same order or have a cumulative length of characters greater than a third value.

5. The method of claim 1 comprising executing a fourth sequential search detecting the non-exact match when the packet and the recognizable network address contain the same first character of one of, and entirety of another one of, multiple contiguous sequences of one or more characters that are in the same order and have a cumulative length of characters greater than a fourth value.

6. The method of claim 1 comprising executing a fifth sequential search detecting the non-exact match when the packet and the recognizable network address contain the same single contiguous sequence of a plurality of characters that have a cumulative length of characters greater than a fifth value.

7. The method of claim 1 comprising dropping predefined keywords in the search from the packet or recognizable network address that have a length of characters less than a sixth value.

8. The method of claim 1, wherein the minimum proximity threshold weighs non-exact matches in prefixes and suffixes less than middle segments of the packet.

9. The method of claim 1 comprising decreasing the minimum proximity threshold to increase a probability of detecting a recognizable address or increasing the minimum proximity threshold to reduce a risk of error in detecting the recognizable address.

10. The method of claim 1 comprising executing a variable gate instruction identified in the packet for the uniquely identified device.

11. A system for network routing, the system comprising:
one or more memories storing a repository of a set of addresses recognizable in a network; and
one or more processors configured to:
receive a packet that can not be routed in a network because it does not contain a recognizable network address in a set of addresses recognizable in the network,
parse the packet to identify a marker indicating a potential network address,
identify one or more recognizable addresses that contain the marker in the set of addresses recognizable in the network,
for each of the identified recognizable addresses containing the marker, iteratively execute multiple sequential searches to detect a non-exact match between the recognizable address containing the marker and data in the packet, wherein in each sequential search a proximity of a matching criteria for the non-exact match is incrementally decreased until a non-exact match is detected or a termination criterion is reached,
address the packet to the recognizable address if a non-exact match thereof in the packet is detected, and
route the packet in the network to a device uniquely identified by the recognizable address.

12. The system of claim 11, wherein the one or more processors are configured to execute a first sequential search detecting the non-exact match when the packet and the recognizable network addresses contain the same multiple contiguous sequences of a plurality of characters that are in the same order and have a cumulative length of characters greater than a first value.

13. The system of claim 11, wherein the one or more processors are configured to execute a second sequential search detecting the non-exact match when the packet and the recognizable network addresses contain the same multiple contiguous sequences of one or more characters that are in the same order and have a cumulative length of characters greater than a second value.

14. The system of claim 11, wherein the one or more processors are configured to execute a third sequential search detecting the non-exact match when the packet and the recognizable network addresses contain the same multiple contiguous sequences of one or more characters that are in the same order or have a cumulative length of characters greater than a third value.

15. The system of claim 11, wherein the one or more processors are configured to execute a fourth sequential search detecting the non-exact match when the packet and the recognizable network addresses contain the same first character of one of, and entirety of another one of, multiple contiguous sequences of one or more characters that are in the same order and have a cumulative length of characters greater than a fourth value.

16. The system of claim 11, wherein the one or more processors are configured to execute a fifth sequential search detecting the non-exact match when the packet and the recognizable network addresses contain the same single contiguous sequence of a plurality of characters that have a cumulative length of characters greater than a fifth value.

17. The system of claim 11, wherein the one or more processors are configured to drop predefined keywords in the search from the packet or recognizable network address that have a length of characters less than a sixth value.

18. The system of claim 11, wherein the one or more processors are configured to weigh prefixes and suffixes less in the minimum proximity threshold than middle segments of the packet.

19. The system of claim 11, wherein the one or more processors are configured to execute a variable gate instruction identified in the packet for the uniquely identified device.

20. The system of claim 11 comprising a network router configured to route the packet in the network to the device uniquely identified by the recognizable address.
